(19) United States
(12) Patent Application Publication
(10) Pub. No.: US 2026/0195806 A1
(43) Pub. Date: Jul. 9, 2026

(54) Integration of Live Multi Cryptocurrency Cross Chain Auctions with a Witness Bonded Settlement and Provenance Layer

(71) Applicants: Angelo John Martino, III, Land O' Lakes, FL (US); Angelo John Martino, JR., Bethel Park, PA (US)

(72) Inventors: Angelo John Martino, III, Land O' Lakes, FL (US); Angelo John Martino, JR., Bethel Park, PA (US)

(21) Appl. No.: 19/411,123

(22) Filed: Dec. 5, 2025

Related U.S. Application Data
(60) Provisional application No. 63/728,168, filed on Dec. 5, 2024.

(51) Int. Cl. G06Q 30/08; G06Q 20/06; G06Q 20/38

(52) U.S. Cl. CPC G06Q 30/08; G06Q 20/0658; G06Q 20/389

(57) ABSTRACT

A live multi-cryptocurrency cross-chain auction system is disclosed that integrates with a witness-bonded settlement and provenance service. An auction engine manages listings and real-time bidding across multiple currencies and blockchain networks, and upon auction close, generates a structured auction-settlement proposal referencing a winning bid, asset identifier, and chain endpoints. The proposal is submitted to the settlement and provenance service, which classifies the transaction into a policy tier, selects bonded witnesses, coordinates digitally signed attestations, selects a settlement route, and verifies settlement evidence. The auction system receives a settlement result including a settlement status, settlement receipt identifier, and coverage metadata, and updates auction records and user interfaces to reflect the settlement outcome and associated provenance reference. The architecture supports digital assets, non-fungible tokens, and physical collectibles linked to digital identifiers and enables programmable coverage, unified cross-chain settlement handling, and durable provenance for auction outcomes.

### CROSS-REFERENCE TO RELATED APPLICATIONS

This application claims the benefit of U.S. Provisional Patent Application No. 63/728,168, filed Dec. 5, 2024, entitled “System and Method for Live Multi-Cryptocurrency Cross-Chain Auctions with AI and NFT Support”, the entire disclosure of which is hereby incorporated by reference in its entirety.

### FIELD OF THE INVENTION

The present disclosure relates to electronic auction systems, distributed ledger technologies, and programmable settlement infrastructure. More particularly, it relates to live multi-cryptocurrency, cross-chain auctions that integrate with a witness-bonded settlement and provenance service to provide programmable coverage, verifiable settlement, and durable asset provenance for both digital and physical items.

### BACKGROUND

Online auction platforms have evolved from single-currency, single-network systems into complex marketplaces where users may bid using different cryptocurrencies, bridge value across heterogeneous blockchains, and buy or sell tokenized representations of physical collectibles, digital art, and other non-fungible tokens (NFTs). Many of these auctions involve cross-chain flows, intermediate custodians, or off-chain settlement steps that are opaque to end users.

Conventional auction engines typically assume that, once an auction closes and a winning bid is determined, settlement is handled by separate payment processors, individual blockchain transactions, or informal agreements between counterparties. These approaches often lack:
a unified notion of settlement coverage or guarantees;
a consistent way to validate heterogeneous proof artifacts such as bridge receipts, light-client proofs, or zero-knowledge proofs;
a durable provenance trail that links auction outcomes to subsequent transfers and physical custody changes; and
any mechanism for witnesses or third parties to bond economic value and stand behind settlement outcomes.

Cross-chain auctions are particularly fragile. They may rely on multiple bridge providers, different consensus and finality rules, and partial off-chain arrangements. If a bridge fails, a transaction reverts, or an intermediary misbehaves, it can be difficult to determine which party bears loss and whether any coverage exists.

At the same time, there is a growing need to link auction outcomes to a separate settlement and provenance layer that can:
classify transactions into risk-aware policy tiers;
require attestations from bonded witnesses who can be economically penalized for misbehavior;
evaluate heterogeneous proofs through a unified meta-verification subsystem; and
record settlement receipts and provenance events in a graph that spans multiple auctions, transfers, and physical custody updates.

Accordingly, there is a need for auction architectures that natively integrate with a witness-bonded settlement and provenance layer, so that auction outcomes are not merely “winning bids” but are connected to structured settlement plans, coverage commitments, and durable provenance records.

### SUMMARY

In some embodiments, a live multi-cryptocurrency, cross-chain auction system is integrated with a witness-bonded settlement and provenance service. An auction engine manages listings, bid books, and auction logic for digital and physical assets, while delegating final settlement and provenance recording to the external settlement and provenance service.

An auction engine receives auction configuration data specifying, for each listing, accepted currencies, supported origin and destination blockchain networks, reserve prices, auction durations, and other parameters. Bidders submit bids denominated in one or more of the accepted currencies and, in cross-chain scenarios, may specify funding sources on different blockchain networks or payment systems. During a live auction period, the auction engine maintains a bid book, normalizes bids into a common comparison metric, and continuously identifies the leading bid or bids.

When an auction closes and a winning bid is determined according to the auction parameters, the auction engine constructs a structured auction-settlement proposal that references the winning bid, an asset identifier, origin and destination chain information, and any settlement constraints such as preferred settlement routes or maximum acceptable fees. The auction-settlement proposal is submitted to the witness-bonded settlement and provenance service through an ingress interface.

A policy engine within the settlement and provenance service classifies the proposal into a policy tier that defines witness requirements, coverage parameters, and eligible settlement routes. Based on the selected policy tier, the settlement and provenance service selects appropriate witness classes, coordinates digitally signed attestations from bonded witnesses, chooses a settlement route (for example, same-chain settlement, hashed-timelock contract settlement, bridge-receipt validation, or optimistic settlement with a challenge period), verifies settlement evidence through a meta-verification subsystem, and records a settlement receipt and provenance update.

The auction engine receives a settlement result including a settlement status, a settlement receipt identifier, and coverage metadata. The auction engine updates the auction listing state to reflect the settlement result, stores or displays a reference to the settlement receipt and provenance graph node, and may gate completion of asset ownership transfer or release of off-platform assets based on the settlement status.

In some embodiments, the auction engine supports auctions for non-fungible tokens, tokenized assets, and physical collectibles that are linked to digital identifiers or physical authentication systems. In certain embodiments, sensor-fusion or physical-authentication evidence associated with the item is attached to the auction-settlement proposal, enabling the settlement and provenance service to treat physical authenticity or custody as part of the settlement conditions. In various embodiments, AI components may be used for non-binding tasks such as suggesting reserve prices, estimating risk profiles, or recommending policy tiers, while the core auction and settlement integration logic remains deterministic and auditable.

By integrating with a witness-bonded settlement and provenance service, the disclosed auction system enables programmable coverage, unified cross-chain settlement handling, and durable provenance for auction outcomes without embedding settlement logic directly into the auction smart contracts or marketplaces.

### BRIEF DESCRIPTION OF THE DRAWINGS

The accompanying drawings, which are incorporated in and form a part of the present specification, illustrate example embodiments and, together with the description, serve to explain principles of the invention. In the drawings:

FIG. 1 is a block diagram of an example live multi-currency auction system integrated with a witness-bonded settlement and provenance service.

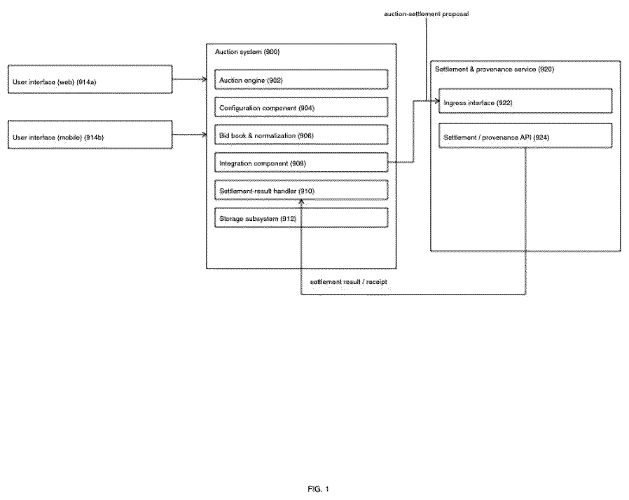

FIG. 2 is a flow diagram illustrating an example auction lifecycle including listing creation, live bidding, auction closure, construction of an auction-settlement proposal, and interaction with the settlement and provenance service.

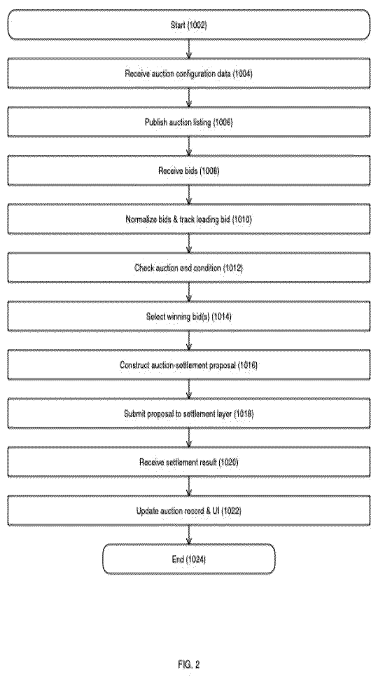

FIG. 3 is a flow diagram illustrating an example cross-chain settlement scenario in which a winning bid is funded on a first blockchain network and settlement is completed on a second blockchain network.

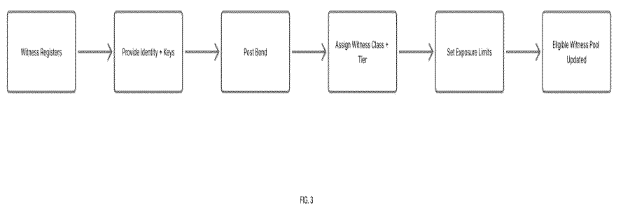

FIG. 4 is a schematic diagram illustrating example use cases for auctions involving digital assets, non-fungible tokens, and physical collectibles linked to digital identifiers and provenance records.

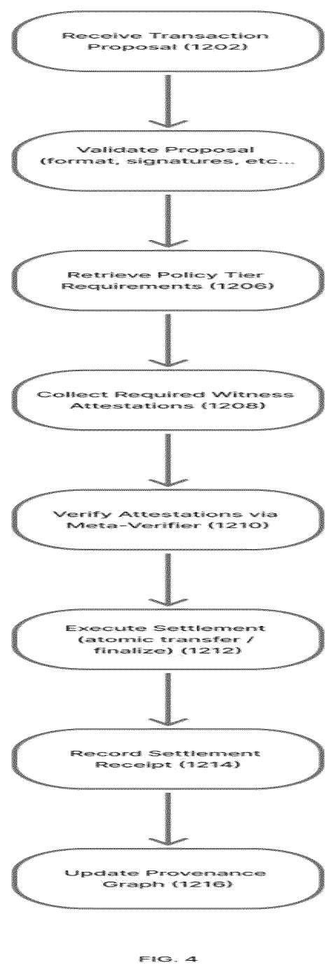

### DETAILED DESCRIPTION OF EXAMPLE EMBODIMENTS

The following detailed description describes certain example embodiments of the invention. The embodiments are presented for purposes of illustration and are not limiting. Other embodiments will be apparent to those of ordinary skill in the art in view of the present disclosure.

For convenience, directional and relative terms such as “first,” “second,” “top,” “bottom,” “above,” and “below” may be used in the description. These terms are used for descriptive purposes and do not limit the relative position or order of the elements so described.

### 1. System Overview

In some embodiments, an auction system 900 is provided for conducting live multi-currency auctions that integrate with a witness-bonded settlement and provenance service 920. The auction system 900 may be implemented as a backend service, a set of smart contracts, one or more web servers, or a combination thereof.

The auction system 900 may include:
an auction engine 902;
a configuration component 904;
a bid book and normalization component 906;
an integration component 908 for communicating with the settlement and provenance service 920;
a settlement-result handler 910; and
a storage subsystem 912 that stores auction records, bid histories, and references to settlement receipts and provenance identifiers.

The settlement and provenance service 920 may include a policy engine, witness registry, attestation orchestrator, meta-verification subsystem, settlement recorder, and provenance manager, as described in greater detail in separate systems. For purposes of the present application, the settlement and provenance service 920 is treated as an external service that exposes an ingress interface for transaction proposals and returns settlement results and provenance references.

In some embodiments, one or more user interfaces 914, such as web interfaces, mobile applications, or marketplace front-ends, interact with the auction system 900 to allow sellers to configure auctions and bidders to place and monitor bids.

### 2. Auction Configuration and Listing Creation

The configuration component 904 is configured to receive auction configuration data from a seller, marketplace operator, or automated process. The auction configuration data may specify:
an asset identifier;
a title and description;
one or more accepted currencies (for example, particular cryptocurrencies or tokens);
one or more supported origin or destination blockchain networks;
a reserve price or starting price;
auction duration and closing rules;
whether fractional or group-purchase participation is allowed; and
optional parameters related to policy tiers or preferred coverage levels.

The auction engine 902 uses the auction configuration data to create an auction listing. The listing is stored in storage subsystem 912 and may be exposed via user interfaces 914 and application programming interfaces (APIs).

In some embodiments, the auction configuration data may include references to digital tokens, NFTs, or physical collectibles. For example, the configuration may include a smart-contract address and token identifier for a non-fungible token, or a physical-asset identifier that links to an external authentication or provenance record.

### 3. Bidding and Bid Normalization

During a live auction period, bidders submit bids to the auction engine 902. A bid may include:
a bidder identifier;
a bid amount denominated in one of the accepted currencies;
an indication of an origin funding source, such as a particular blockchain network and funding address;
optional preferences or constraints, such as a maximum acceptable fee or preferred settlement route; and
optional metadata identifying whether the bid is part of a group-purchase arrangement or fractional-ownership structure.

The bid book and normalization component 906 maintains a bid book for each auction. When bids are denominated in different currencies, component 906 may normalize the bids into a common comparison metric, for example by obtaining exchange-rate information from one or more data sources and converting bid values into a reference currency.

The auction engine 902 uses the normalized values to identify leading bids during the live auction period. User interfaces 914 may display current leading bids or best prices while the auction remains open.

### 4. Auction Closure and Winning Bid Selection

At or after the scheduled closing time, and subject to any closing rules (such as anti-sniping extensions or minimum bid increments), the auction engine 902 determines that the auction has closed. The engine selects at least one winning bid according to the auction parameters, such as the highest bid or top N bids in the case of multiple-unit or fractional auctions.

In some embodiments, if the auction allows group purchases or fractional ownership, multiple winning bidders may be selected, each with an associated fractional allocation of the asset and a corresponding payment obligation.

### 5. Construction of Auction-Settlement Proposals

After a winning bid or bids are selected, the integration component 908 constructs an auction-settlement proposal. The auction-settlement proposal may include:
the asset identifier;
one or more winning bidder identifiers;
the winning bid amount or amounts;
identification of one or more origin funding sources, such as blockchain networks and funding addresses;
one or more destination addresses or accounts;
auction identifiers and metadata; and
one or more settlement constraints, such as preferred settlement route type, maximum acceptable fees, or time constraints.

In some embodiments, the auction-settlement proposal is formatted according to a schema defined by the settlement and provenance service 920 so that it can be received and processed by the service's ingress interface.

The integration component 908 transmits the auction-settlement proposal to the settlement and provenance service 920, which treats the proposal as a transaction proposal suitable for policy evaluation and settlement planning.

6. Interaction with the Settlement and Provenance Service

Upon receiving the auction-settlement proposal, the settlement and provenance service 920 may:
evaluate the proposal using a policy engine that classifies the proposal into a policy tier based on value, risk factors, asset type, and chain combinations;
select one or more witness classes and bonded witnesses from a witness registry;
coordinate witness attestations that bind the witnesses to the transaction, policy tier, and candidate settlement route;
construct and execute a settlement plan using a settlement optimizer;
verify heterogeneous settlement evidence using a meta-verification subsystem; and
record a settlement receipt and provenance update in a provenance graph.

The auction system 900 treats the settlement and provenance service 920 as an external, witness-bonded settlement layer that returns a settlement result.

The settlement-result handler 910 receives a settlement result from the settlement and provenance service 920. The settlement result may include:
a settlement status (for example, “pending,” “completed,” or “failed”);
a settlement receipt identifier;
one or more coverage-tier indicators;
optional references to provenance graph nodes or hashes; and
optional reason codes or diagnostics in case of failure.

### 7. Updating Auction Records and Provenance

Upon receiving the settlement result, the settlement-result handler 910 updates the auction record in storage subsystem 912. The update may include:
recording the settlement status;
storing the settlement receipt identifier;
storing a coverage tier or coverage amount; and
storing a reference to a provenance graph node or external provenance record maintained by the settlement and provenance service 920.

User interfaces 914 may display settlement status and, in some embodiments, provide links or identifiers that enable parties to view the corresponding settlement receipt or provenance record through the settlement and provenance service 920 or a separate explorer.

In some embodiments, the auction engine 902 prevents completion of any transfer of asset ownership, release of digital tokens, or off-platform delivery workflows until the settlement status indicates that settlement has been successfully verified and accepted by the settlement and provenance service 920.

### 8. Digital Assets, NFTs, and Physical Collectibles

In some embodiments, the auction system 900 is used for auctions involving purely digital assets, such as fungible tokens or NFTs. For NFTs, the auction-settlement proposal may additionally identify a smart contract address and token identifier. The settlement and provenance service 920 may require evidence of on-chain transfers, bridge events, or other digital settlement events.

In other embodiments, the auction system 900 is used for physical collectibles such as trading cards, sports memorabilia, artwork, luxury goods, or authenticated merchandise. For these items, the auction configuration data may include a physical-asset identifier that is linked to one or more physical authentication or provenance systems. The auction-settlement proposal may include references to physical authentication events or sensor-fusion evidence that the settlement and provenance service 920 treats as part of the settlement context.

### 9. Group Purchases and Fractional Ownership

In some embodiments, the auction engine 902 supports group purchases or fractional ownership auctions. In such embodiments:
multiple bidders may be selected as winners, each associated with a fractional share or entitlement;
the auction-settlement proposal may describe a distribution of payment obligations and entitlement among the winners; and
the settlement and provenance service 920 may record in its provenance graph that the asset identifier is associated with multiple parties in fractional proportions.

The settlement result and the auction record may include details of the fractional allocations and may be used to coordinate future transfers or settlements among fractional owners.

### 10. Error Handling and Settlement Exceptions

In some embodiments, if the settlement and provenance service 920 returns a settlement result indicating failure or insufficient evidence, the settlement-result handler 910 records a settlement exception associated with the auction listing. The exception may describe the failure reason and may be used in dispute resolution or governance processes.

The auction engine 902 may, for example, offer the asset to the next highest bidder, re-run the auction, or mark the auction as requiring manual review depending on configured rules.

### Alternative Embodiments

Alternative embodiments of the disclosed auction system may vary in implementation details while remaining within the scope of the invention.

In some embodiments, the auction engine 902 is implemented primarily as one or more smart contracts operating on a blockchain network, with off-chain services handling interaction with the settlement and provenance service 920. In other embodiments, the auction system 900 is implemented predominantly off-chain with optional on-chain anchoring of critical events.

In some embodiments, the normalization component 906 uses different exchange-rate providers or applies time-weighted averages to mitigate market volatility. In other embodiments, the system may limit acceptable currencies or chains based on risk profiles or coverage availability. In some embodiments, the auction system 900 includes optional AI-driven modules for suggesting reserve prices, auction durations, or recommended policy tiers, based on historical data, risk factors, or asset characteristics. These AI modules may provide non-binding recommendations, while final auction and settlement logic remains deterministic and auditable.

In some embodiments, the integration component 908 supports multiple witness-bonded settlement and provenance services, and the auction configuration data may specify a preferred service or allow selection based on policy or cost.

The foregoing embodiments are illustrative and are not intended to limit the scope of the invention, which is defined by the claims.

1. A computer-implemented method for conducting a live multi-currency auction integrated with a witness-bonded settlement and provenance service, the method comprising:
(a) receiving, by an auction engine, auction configuration data for an item, the auction configuration data specifying at least one accepted currency, at least one supported origin or destination blockchain network, and one or more auction parameters;
(b) publishing, by the auction engine, an auction listing based on the auction configuration data and receiving bids from a plurality of bidders, at least some of the bids being denominated in different currencies or corresponding to different blockchain networks;
(c) maintaining, during a live auction period, a bid book that normalizes the plurality of bids into a common comparison metric and determines at least one leading bid;
(d) upon closure of the auction, selecting a winning bid from the bid book according to the auction parameters;
(e) constructing, by the auction engine, an auction-settlement proposal comprising at least the winning bid, an asset identifier, information identifying an origin funding source, information identifying a destination address, and one or more settlement constraints;
(f) transmitting the auction-settlement proposal to a witness-bonded settlement and provenance service through an ingress interface exposed by the settlement and provenance service;
(g) receiving, from the settlement and provenance service, a settlement result comprising a settlement status, a settlement receipt identifier, and coverage metadata determined by a policy engine and bonded witnesses of the settlement and provenance service; and
(h) updating, by the auction engine, a state of the auction listing to reflect the settlement result, including storing or displaying at least the settlement status and the settlement receipt identifier.

2. The method of claim 1, wherein the auction configuration data specifies a plurality of accepted cryptocurrencies and maintaining the bid book comprises converting bids into a normalized price using one or more exchange-rate sources.

3. The method of claim 1, wherein the auction-settlement proposal further comprises a preferred settlement-route type selected from a group consisting of same-chain settlement, hashed-timelock contract settlement, bridge-receipt validation, and optimistic settlement with fallback.

4. The method of claim 1, wherein the settlement result includes a coverage tier indicating a level of settlement assurance and a maximum coverage amount for a potential shortfall or failure.

5. The method of claim 1, wherein updating the state of the auction listing includes recording a reference to a provenance node maintained by the settlement and provenance service.

6. The method of claim 1, further comprising preventing completion of an ownership transfer within the auction system unless the settlement status indicates that settlement has been successfully verified by the settlement and provenance service.

7. The method of claim 1, wherein the bids include cross-chain funding instructions specifying an originating blockchain network and funding address for each bid.

8. The method of claim 1, wherein the auction engine is configured to display to a bidder, prior to auction closure, at least one projected policy tier or coverage level associated with the bidder's bid based on at least one of bid value, asset type, or a cross-chain route.

9. The method of claim 1, wherein the item corresponds to a non-fungible token and the auction-settlement proposal additionally identifies a smart contract address and token identifier associated with the item.

10. The method of claim 1, wherein the item corresponds to a physical collectible and the auction-settlement proposal additionally includes a physical-asset identifier linked to a separate authentication or provenance record.

11. The method of claim 1, further comprising receiving, from the settlement and provenance service, a provenance-graph reference that reflects prior settlement events involving the asset identifier and storing the provenance-graph reference in association with an auction record.

12. The method of claim 1, further comprising, upon detection of a failed or incomplete settlement, generating a settlement exception record that references the settlement receipt identifier and is associated with the auction listing for use in dispute resolution.

13. A system for conducting live multi-currency auctions integrated with a witness-bonded settlement and provenance service, the system comprising:
(a) an auction engine configured to manage auction listings, accept bids from bidders, evaluate leading bids during a live auction period, and select winning bids at auction closure;
(b) a configuration component configured to receive auction configuration data specifying at least one accepted currency, at least one supported blockchain network, and one or more auction parameters;
(c) a normalization component configured to normalize bids denominated in different currencies or originating from different blockchain networks into a common comparison metric;
(d) an integration component configured to construct auction-settlement proposals for winning bids and transmit the auction-settlement proposals to a witness-bonded settlement and provenance service;
(e) a settlement-result handler configured to receive settlement results from the settlement and provenance service and to update auction records based on the settlement results; and
(f) a storage subsystem configured to store auction records, bid histories, and references to settlement receipts and provenance identifiers provided by the settlement and provenance service.

14. The system of claim 13, wherein the integration component is further configured to include, in each auction-settlement proposal, an asset identifier, an origin funding source, a destination address, and one or more settlement constraints.

15. The system of claim 13, wherein the settlement-result handler is configured to store a coverage tier and settlement status associated with each winning bid.

16. The system of claim 13, wherein the auction engine is further configured to provide, in a user interface, an indication that settlement coverage is being provided via the witness-bonded settlement and provenance service.

17. The system of claim 13, wherein the storage subsystem is further configured to store references to provenance-graph nodes maintained by the settlement and provenance service that correspond to auction outcomes.

18. A non-transitory computer-readable medium storing instructions that, when executed by one or more processors, cause the one or more processors to perform the method of claim 1.

19. The method of claim 1, wherein the settlement and provenance service determines the settlement result by performing policy-tier classification, witness selection, attestation orchestration, and meta-verification of settlement evidence.

20. The method of claim 1, wherein the settlement and provenance service records, in its own provenance graph, a settlement receipt node associated with the auction-settlement proposal and provides a reference to the settlement receipt node as the settlement receipt identifier.

21. The method of claim 1, wherein the live auction period is synchronized across multiple front-ends or regions using a consensus timestamp, and the settlement-result handler is configured to resolve race conditions based on confirmed settlement events.

22. The system of claim 13, wherein the auction engine is further configured to support group-purchase or fractional-ownership auctions in which the auction-settlement proposal identifies multiple winning participants and corresponding fractional allocations.

23. The system of claim 13, wherein the integration component is further configured to attach sensor-fusion evidence or physical-authentication references to the auction-settlement proposal when the item is a physical collectible.

24. The method of claim 1, wherein maintaining the bid book comprises tracking multiple bid legs that correspond to different blockchain networks and ensuring that a winning bid complies with chain-specific constraints or withdrawal limits prior to constructing the auction-settlement proposal.
